(19) United States
(12) Patent Application Publication
(10) Pub. No.: US 2005/0049973 A1
(43) Pub. Date: Mar. 3, 2005

(54) Method and program for automated management of software license usage by monitoring and disabling inactive software products

(76) Inventors: Mark A. Read, Stavanger (NO); Gisle Hannemyr, Oslo (NO); Oystein Fosli, Oslo (NO); Svein Nedrehagen, Sandnes (NO)

Correspondence Address: Jacques M. Dulin, Esq.;Innovation Law Group, Ltd., NetPort Center, Suite 201, 224 W. Washington Street, Sequim, WA, 98382-3338, US

(21) Appl. No.: 10/932,412

(22) Filed: Sep. 2, 2004

Related U.S. Application Data
(60) Provisional application No. 60/499,432, filed on Sep. 2, 2003.

(51) Int. Cl. G06F 17/60

(52) U.S. Cl. 705/59

(57) ABSTRACT

Method and automatic software application for monitoring and controlling usage of application-type and operating system software programs under bulk software licenses to organizations to cost-effectively utilize software license usage rights. The program automatically monitors and identifies fallow program usages based on criteria that are configurable selectable, disables the fallow program(s) to free-up one or more licenses, and then withdraws the license rights thereto and notifies the user of the disabled program of the action taken. The disabling of a program or application is on the basis of the least disruptive to the user, and the user may have the program re-enable the program. Enterprise-selected priorities can be assigned to related programs to permit completion of tasks in process, in preference to other users. The program may itself, or via a license manager redistribute, or make available freed-up license rights as needed in the organization.

### CROSS REFERENCE TO RELATED APPLICATION

This application is the Regular U.S. application of Applicants' Provisional Application Ser. No. 60/499,432 filed Sep. 2, 2003, entitled Method for Optimizing Software License Usage by Monitoring and Disabling Inactive Software Products, the priority of which application is hereby claimed under 35 US Code §119.

### FIELD

The invention relates to software and methods of computer operation, and more particularly to management of efficient and optimal usage of software licenses by software-enabled automatic monitoring of the status of use activity of selected licensed software or program(s) of one or more user(s), seat(s) or site(s) (which may include multiple seats), in order to determine whether the program or application is in use, disabling fallow (un-used or un-needed) software, and harvesting the licenses for redistribution to other users, seats or sites on a need basis in order to lower overall software costs by reducing the number of bulk or multi-user licenses required throughout an entire organization or enterprise.

### BACKGROUND

Software is primarily licensed for customer use, not sold. For individuals, the license is typically for use at a single site or single computer, with the right to make a recovery back up disc. The underlying code and the underlying intellectual property functionality rights are not owned by the user.

In the case of larger enterprise or organization users, primarily small companies to major corporations, there are ranges of user licenses, from a few seats or user licenses up to entire enterprise license rights comprising hundreds of computer work-stations, mobile laptop or PDAs, users, sites, or a complex mix of all such location and user rights.

There exist different schemas for quantifying the number of licenses of an application or part of an application that are needed for a site or organization, normally specified by a maximum number which refers to the total number of:
1. Simultaneous users allowed to access an application or part of an application;
2. Different users (named users) allowed to access an application; and
3. PCs or seats where the software is installed.

As the number of users and sites change, or the programs become obsolete or updated, or the projects within the enterprise change, such that fewer or more users need access/use rights to a particular program or version, the task of administrating the license requirements becomes increasingly complex. Indeed, the task exponentially increases as the size of the enterprise increases, due to the constantly changing assignments within the organization and the increasing size of personnel turnover, as well as program obsolescence or feature upgrades. Further, the need for enterprise network level and seat level security and virus protection compounds the management problems.

Also, that an application has been or is running on the computer does not necessary means that it has been used to do any productive work. It may just have been started and left idle.

To find out, and stay at the correct number of licenses are very important management tasks for every company, as use rights licenses can run into millions of dollars annually. Although some companies may have a good overview of what licenses are purchased, and even installed, very few actually have an overview of how the licenses are utilized.

Accordingly, there is an unsolved need in the art for a truly accurate and automatic system for accurately auditing usage to determine how many licenses are required, and if a particular program license is not in active use by particular seats or users, redistribute it or make it available to other potential users in order for the most efficient cost benefit usage and savings to the enterprise.

### THE INVENTION

Terminology:

As used in this Application, the following terms have the definitions given below, which definitions are not to limit the use and functionality of the claimed invention, but are provided for ease of understanding of the descriptions of the functionality and operation of the inventive program and methods.
License Server: A program run on a computer or another device in a network that, depending on a configuration (license file), serves out licenses to users, seats or sites according to the limitations described in the configuration.
Program: A file or set of files that contain(s) computer instructions that perform a certain task or a set of tasks.
Application: A single program or a set of programs, including operating system and application-type programs; the terms applications and programs may be used interchangeably.
Instance: Instance of a program refers to an execution of the program i.e. the processing, in the CPU and memory, of the program. There can be one or more instance of a program running at the same time.
Kernel level: The internal level of the operating system.
User level: The external level of the operating system.
Suspended: Is the state of a program in which it is stopped from running, but an image of the process, including text, stack and data segment is kept in memory (RAM) until: a) the process is swapped out to disk (in which case it is in hibernation); or b) it is continued (resumed) from the suspended state, at which time it will continue from where it left off, as if nothing had happened.
Hibernated: The state of a program in which it is stopped from running (as in the suspended state), but here an image of the process is stored to disk (permanent storage) to free up the RAM resources for use for other program processes. When the process is awakened, it will be moved back to memory (RAM), then resume and continue from where it left off, as if nothing had happened (except for a delay).
Dekeyed: A program is dekeyed when it is removed from the registry (in Windows®) or if a certain key that is needed for the software to start has been removed.
Corrupted: A program is corrupted if it has been altered in a way that it cannot be executed.
Terminated: A program is terminated when it is halted and removed from the process table and memory, either by the user or by the system itself. It does not run until started again.
Uninstalled: A program is uninstalled when it is removed from the system by a proper uninstall procedure, so it is not available until installed again.
Disabled/Enabled: The state of whether an application or program can be operated by a user or not. “DISABLE” refers to “executing an operation to invalidate the requirement of a program to have a license for the operation of a particular software program product”, while “ENABLE” refers to “executing an operation to revalidate or add the requirement for a license for the operation of a particular software product.” Examples of disabling an instance of an application depend on the precise configuration of the particular subject application or program to be disabled to free up the license linked or associated with it to be redistributed pursuant to the inventive process, and can include one or more of the following actions such as: uninstalling, corrupting, de-keying, terminating and suspending. Thus, an application that is unable to do anything before the action that disabled it is reversed, is considered to be in a disabled state. Enabling or enabled is the reverse action or result thereof, e.g., reinstallation, recovery from corruption, re-keyed, restarted, activated, or the like.
Freeze/Thaw: A special case of Disable/Enable, respectively. Freeze broadly covers both “suspend and hibernate” states of program stoppage, and thaw covers both “awaken and continue” from a prior suspend or hibernation.

### SUMMARY, INCLUDING OBJECTS AND ADVANTAGES OF THE INVENTION

It is among the objects and advantages of the invention to provide an automatic, software-driven and managed computerized system that monitors usage of particular, selected software applications, including operating system and application-type programs, to determine their level of activity, and to identify those that are inactive in order to better utilize the software licenses effectively within an organization.

It is another object to provide a method for automatically managing, in a cost effective manner, the efficient and optimal usage of enterprise-licensed software or programs by disabling software that is by definition un-needed or inactive in order to free-up the license for redistribution to other computers, users, sites or seats for programs and/or applications requiring licenses for use.

Additional objects and advantages will be evident by an analysis of the specification, and as illustrated in an exemplary enablement shown in the Appendix.

The inventive method and program automatically identifies fallow program usages, both in system software and applications software, disables the fallow program(s) to free-up one or more licenses, and then withdraws the license rights thereto. It then follows one or more of the following alternatives, singly or in sequence: It distributes, redistributes, or makes available, the freed-up license rights as needed among selected or defined users, groups of users, seats or sites based on eligibility priorities (or rankings) that can be pre-determined in accordance with enterprise policies, business rules and thresholds of use activity. The inventive program can also add the free-up licenses to an inventory, automatically distribute from the inventory, and optionally notify users that their license have been terminated or withdrawn, or that a license to a particular program is available. The result of the method and operation of the program is to lower overall software costs by reducing the number of bulk or multi-user licenses required throughout an entire organization or enterprise.

The inventive software-driven system optimizes license usage by monitoring software activity and executing in response thereto operation(s) to disable software products determined by selected criteria in the program to be currently inactive. The disabling of a program or application is on the basis of the least disruptive to the user, and notice to the user is a feature of the preferred embodiment. The inventive program can also enable, or re-enable, the disabled program after notice to and response from the user of the disabled program. In other embodiments, organization or enterprise-defined or selected priorities can be assigned to linked or related programs or to users to permit completion of tasks or projects in process in preference to other users.

Often it happens that a user's computer or application is left in a state where it has assigned thereto a license (also referred to as “using” or “uses” a license), but the licensed program is actually not doing anything productive. This could be because the user is in a meeting, or that he/she is away on holiday, or may even have left the company. There may be no longer any reason for that user to “occupy” (be assigned or use) a license and thereby hinder others from utilizing the software resource.

There exist various commercially available software products for limiting the usage of an application, by controlling access to software, based, for example, on concurrent usage (license managers). Such license managers simply block access to software or do not give out licenses (or rights to licenses) if there are no remaining licenses in inventory.

But there is no software available for automatically disabling already distributed licensed applications, because and when they are not in active use.

In addition, there is currently available commercial software, such as the Open iT®License brand enterprise metering tool, that helps the user manually free software licenses from license managers, and thus enable users to free-up particular, unproductive (selected, unused) license(s) from license manager program inventory.

However, that software does not disable the particular software product or application, prior to removal of the license for the possible adverse result(s) being:
1. The application may continue to run without a license, thus breaching the license agreement; or
2. The application may crash, become frozen (non-responsive), exit unexpectedly or exit without opportunity to save work in progress, or the like; or
3. The application may immediately check out a new license, i.e. nullifying the effort of “freeing up the software license”.

The inventive software system prevents any of the above from happening, minimizes disruption of the user to the extent the user license agreement permits, while helping the organization to increase the efficiency of license utilization.

Accordingly, the inventive automatic software program is a license use optimizing tool that monitors activity levels of installed software, automatically freezes dormant instances, freeing unused licenses for active users and high priority projects, for truly targeted license management. It recovers licenses from dormant programs (or instances), automatically turns off inactive software and licenses, permits on-demand license use by activating programs upon user request, and permits optimizing software license use by pre-determined policies, rules, eligibilities and priorities assigned users and/or projects.

The inventive automatic program aligns software running time with active use time, limits license use to actual software use and/or users, and allows prioritizing software license use by task or project importance; that is, it operates a priority-based system of license management. The inventive automatic system also enables selective creation of pre-set “down times” for software and licenses during which an instance cannot be initialized or continued, for any pre-determined enterprise policy reason, e.g., project or task priority, other user higher priority, upgrading, security, or the like.

Taking cues from keyboard activity, mouse activity, CPU usage, I/O activity, and pre-set enterprise or user customizable criteria, the enterprise software license requirements are selectively and automatically invalidated from users/workstations deemed inactive by the activity and/or criteria. Thus, inactive or unused licenses/software is disabled or frozen from use for the inactive users, or for pre-determined low-priority users in high-demand work periods, or for periods of higher priority tasks, or for projects being worked-on by other users. The inventive program automatically reactivates, reinstates or re-enables software for active or high-priority users, and in the case of interactive programs, sends a desktop message to newly disabled software users, permitting them to block disablement or to re-enable their program with a click on the screen. Optionally the blocking or re-enablement is dependent on the user meeting appropriate eligibility criteria, including but not limited to: enterprise policy and/or use rules relating to priority-ranking assigned the user and thresholds of use.

The inventive program is automated, and all the control parameters are fully configurable. For example, continued license use or activation by new users can be limited to exclude idle time, and specified to accommodate particular users, user groups, sites, enterprise units, projects, tasks and the like, according to pre-determined priorities and any given number of available licenses. For example, the license availability and/or use can be set in the configuration input features of the inventive program to respond to license utilization needs in prime time, for high-demand workloads or projects, as well as for expected periods of less activity and lower production needs.

Thus, the inventive program permits a proactive, feed-forward system of control of license usage, rather than an after-the-fact determination of excess use. This permits maximum license performance and is cost effective by eliminating superfluous licenses. Finally, it includes essentially real-time tracking of license usage in accord with the policies and criteria established by the enterprise, permitting management to determine when, based on actual, real use, additional licenses may be required, or the numbers of licenses can be reduced.

### BRIEF DESCRIPTION OF THE DRAWINGS

The invention is described in more detail with reference to the attached drawings, in which:

FIGS. 1a, 1b and 1c are flowcharts for depicting the inventive process and flow of control steps initiated at various stages by the inventive software;

FIG. 1a illustrates the inventive process steps for identification of the candidate software application(s) that can be disabled pursuant to predetermined criteria, followed by disabling the application(s) to free the license(s) to the interactive query stage;

FIG. 1b illustrates the interactive application branch of the inventive process of FIG. 1a including the added steps of querying the user, assessing if licenses are available when the user wants to re-enable the application, and revalidating or adding the requirement for the program application to have a license, thereby again activating said licenses where the user elects to enable the application again;

FIG. 1c illustrates the non-interactive branch of the inventive process, as a second embodiment of the enabling process steps, similar to FIG. 1b, but where no user interactive engagement is involved, e.g., typically through the initiative of a batch scheduler; and

FIGS. 2a, 2b and 2c are exemplary embodiments of the operation of the inventive software driven system of monitoring, disabling, harvesting of licenses and redistribution of licenses on an as-needed basis within an enterprise.

### DETAILED DESCRIPTION, INCLUDING THE BEST MODES OF CARRYING OUT THE INVENTION

The following detailed description illustrates the invention by way of example, not by way of limitation of the scope, equivalents or principles of the invention. This description will enable one skilled in the art, to make and use the invention, and describes several embodiments, adaptations, variations, alternatives and uses of the invention, including what is presently believed to be the best modes of carrying out the invention.

In this regard, the invention is illustrated in several figures, and is of sufficient complexity that the many parts, interrelationships, and sub-combinations thereof simply cannot be fully illustrated in a single patent-type drawing. For clarity and conciseness, several of the drawings show in schematic, or omit, parts that are not essential in that drawing to a description of a particular feature, aspect or principle of the invention being disclosed. Thus, the best mode embodiment of one feature may be shown in one drawing, and the best mode of another feature will be called out in another drawing.

All publications, patents and applications cited in this specification are herein incorporated by reference as if each individual publication, patent or application had been expressly stated to be incorporated by reference. All product, services and brands mentioned herein are trademarks and/or registered trademarks of their respective owners.

In this detailed description of the invention we refer to the flow charts attached. It is to be understood, however, that the present invention may be embodied in various forms. Therefore, specific details disclosed herein are not to be interpreted as limiting, but rather as a basis for teaching the one skilled in the art to employ the present invention in virtually any appropriately detailed system, structure or manner.

As one skilled in this art will readily understand, the software managed and operated computer(s) of the invention can be configured in a system architecture, for example, as one or more server computer(s), database (both relational and hierarchical) computer(s), storage computer(s), routers, interfaces, and peripheral input and output devices, that together implement the system and network. A computer used in the inventive system typically includes at least one processor and memory coupled to a bus. The bus may be any one or more of any suitable bus structures, including a memory bus or memory controller, peripheral bus, and a processor or local bus using any of a variety of bus architectures and protocols. The memory typically includes volatile memory (e.g., RAM) and fixed and/or removable non-volatile memory. The non-volatile memory can include, but is not limited to, ROM, Flash cards, hard disk drives including drives in RAID arrays, floppy discs, mini-drives, Zip drives, Memory sticks, PCMCIA cards, tapes, optical drives such as CD-ROM drives, WORM drives, RW-CD ROM drives, etc., DVD drives, magneto-optical drives, and the like. The various memory types provide for storage of information and images, including computer-readable instructions, data structures, program modules, operating systems, and other data used by the computer(s).

A network interface is coupled to the bus to provide an interface to the data communication network (LAN, WAN, and/or Internet) for exchange of data among the various site computers, routers, customer computing devices, and product vendors. The system also includes at least one peripheral interface coupled to the bus to provide communication with individual peripheral devices, such as keyboards, keypads, touch pads, mouse devices, trackballs, scanners, printers, speakers, microphones, memory media readers, writing tablets, cameras, modems, network cards, RF, fiber-optic, and IR transceivers, and the like.

A variety of program modules can be stored in the memory, including kernel OS, system programs, application programs, and other program modules and data. In a networked environment, the program modules may be distributed among several computing devices coupled to the network, and used as needed. When a program is executed, the program is at least partially loaded into the computer memory, and contains instructions for implementing the operational, computational, archival, sorting, screening, classification, formatting, rendering, printing and communication functions and processes described herein.

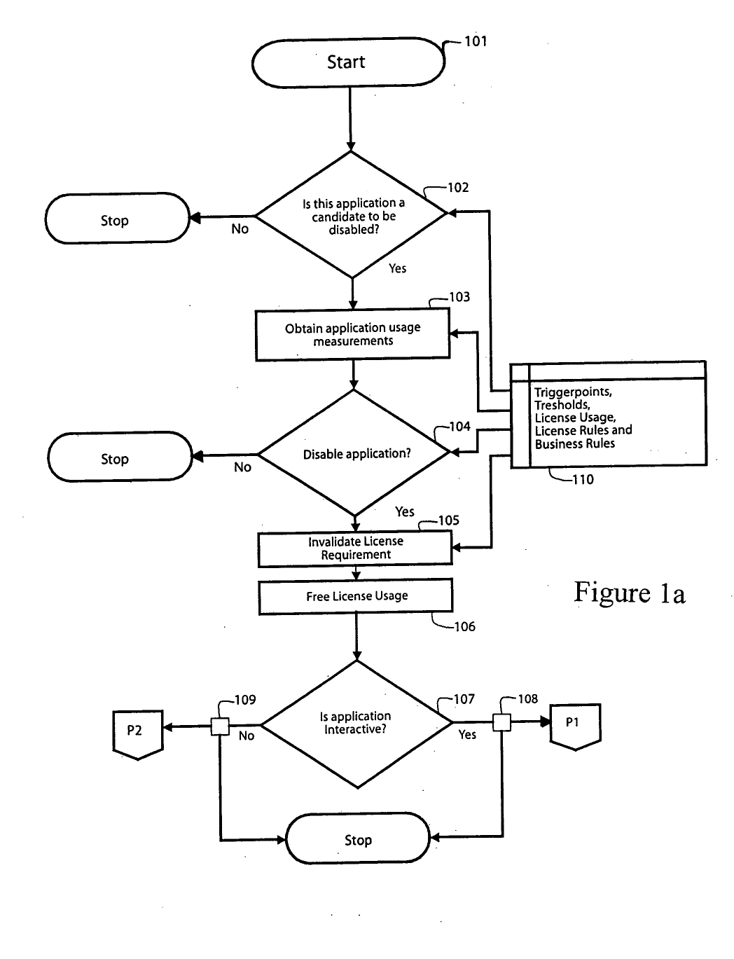

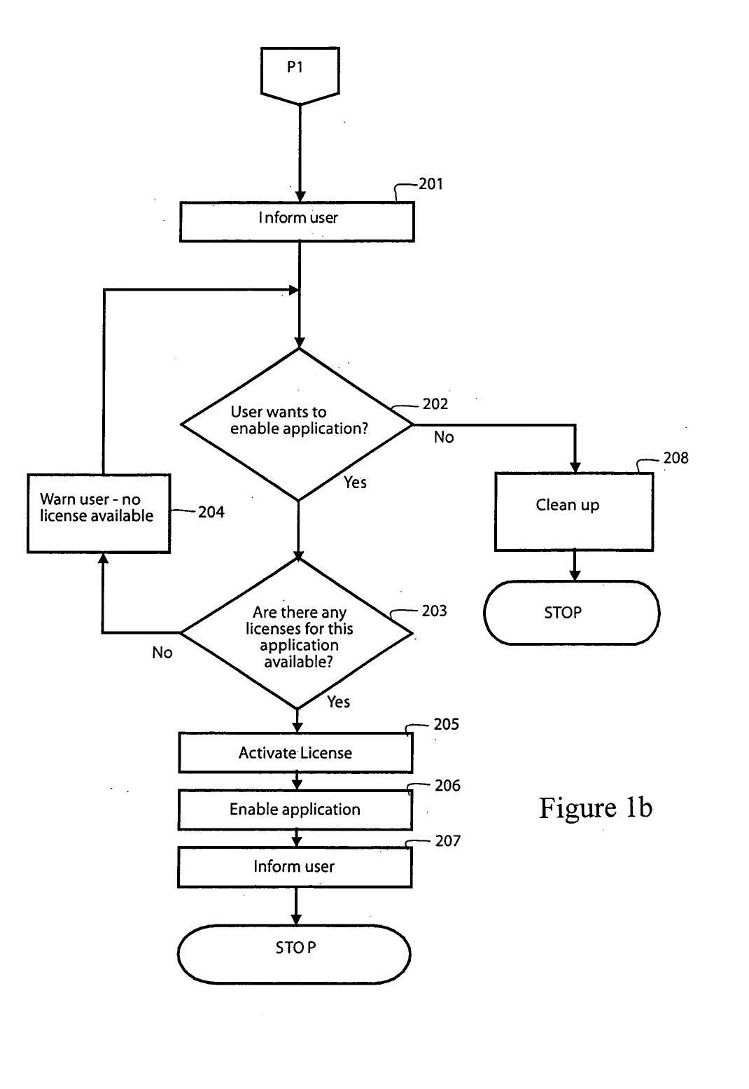

7.1 FIG 1a

Turning now to FIG. 1a, imitation of the inventive process, at “Start” 101, may take place in a variety of conventional ways, such as a cron or a sentinel process starting a mother process that in turn starts the inventive program process that runs the following steps for each application running on a designated computer that is to be evaluated for license management. Note the policy module 110 to the right of steps 102-105, lists by way of example and not by way of limitation: Trigger points, Thresholds, License Usage, License Rules and Business Rules, all of which may vary from organization to organization as will be evident from the description below. The selections made in configuring the inventive program process by or for a given organization, before or at installation, or iteratively or recursively during use, will provide parametric limitations on the automatic process execution steps.

Step 102—Is This Application a Candidate to be Disabled?

Not all applications should be considered for disabling at all, and some applications should be considered for disabling only under certain circumstances. Therefore, the inventive process includes configurable criteria for defined trigger points to determine when a particular application is to be considered for disabling. Those trigger points may vary, e.g., depending on the time of day. Furthermore, trigger points may be defined, and thereby configured, in terms of enterprise usage information, such as: How many licenses are currently being utilized for this application? Such enterprise information may be obtained as input from a license enterprise-metering tool, such as the Open iT® License brand program.

110-Policy Module.

The rules for when an application is considered for disabling or if it should be considered to be disabled at all, are defined in the policy module. Exemplary Rules are:

| Application | Rule | Action based in trigger points |
|---|---|---|
| Windows ® 2000 | W21 | Never (never consider disabling Windows ® |
| | | operating system), or |
| Open Works ® | OW1 | For Weekdays 7 am-9 am: Consider dis- |
| | | abling if more than 50% of OpenWorks |
| | | licenses are currently in use, or |
| OpenWorks ® | OW2 | Consider disabling of more than 70% of |
| | | OpenWorks licenses are currently in use, or |
| OpenWorks ® | OW3 | Consider disabling if user is running another |
| | | instance of the software. |

There is an implicit “OR” between the rules. It is enough that one rule satisfies the requirements, then the application should be considered for disabling. It should be noted that Rule OW2 only has meaning for the time period when OW1 does not apply. The policy module also contains a lot of other information like threshold values, priorities between users etc. For an example please see Appendix A.

Step 103—Obtain Application Usage Measurements.

The applications of the selected enterprise computers, workstations, seats or sites are monitored with respect to one or more of, but not limited to, the following parameters:
1. Keyboard activity (KB)
2. Mouse activity (MA)
3. CPU usage (CPU)
4. I/O activity (I/O)
   One skilled in the art will recognize that additional parameters may be defined and selected to be monitored, where determined to be applicable. Non-limiting examples of additional parameters include, e.g., use by an application of another transducer (input device) such as light pen, touch screen pressure, stylus, voice activation input signals, and the like. Further, the usage of another device, such as a floating point unit, graphics card, audio card, printer, burner or the like, may be considered as a parameter to be monitored. The selected parameters are measured with respect to the different applications, either on the kernel level, device level or at the user level.

Tracking Keyboard (1) and Mouse (2) Activity:

There are several methods for implementing monitoring these parameters. For example, logging keyboard and mouse activities with respect to users and applications may be implemented in the Windows®, Linux® and various Unix® environments as follows:

Windows® environment: A DLL is used to set Windows hook procedures into the Windows hook chains, and mouse events and keyboard events passed on to any application that are monitored. The DLL is processed in the address space of the applications that receive the events. Information about the application and use of the application is extracted, together with the event information, and made available to the inventive program for further possessing. In addition, the user running the desktop is also identified.

Unix®/Linux® environment: The IP connection between the X-clients (application servers) and the X-servers is analyzed. All connections from the application servers are listened to for mouse and keyboard activity. When such activity is found, which user and application it came from is determined and the activity is metered.

Events are received in a chronologically ordered stream. This events chronology stream is analyzed to identify and create work periods and break periods, according to the time of the events and the length of the time span between them. Both periods and events are logged.

Tracking CPU (3) and I/O (4) Activity Accurately:

This activity can be tracked by several methods. For example, obtaining CPU usage and I/O activity for processes on Windows and Unix®/Linux® environment may be implemented as follows:

Windows® environment: This information is obtained by adding PDH counter objects for each instance (process) monitored. To get CPU usage, the “\\Process(<instance>)% Processor Time” counter is summed. To get I/O activity, the “\\Process(<instance>)I/O Data Bytes/sec” counter is summed.

Unix®/Linux® environment: This information needs to be as accurate and high granularity as possible; it can be obtained by polling either the Unix®/Linux® process tree or the application process structure.

Then, the monitored object (processes, etc) activities are mapped to applications by a table as included with the invention. This table may be amended and extended by the user organization. It should be understood that the associated objects monitored to obtain measurements do not necessarily reside on the same computer, and may vary by application and according to the determinants identified in the policy module 110 in FIG. 1a.

Step 104—Criteria for Causing the Application to be Disabled

To determine the criteria for the inventive program to automatically cause the application to be disabled, the invention makes use of a function that by using the measurements and thresholds value will determine whether the application is idle or not:
ƒ(E[1],E[2], . . . ,E[N],T[1],T[2], . . . ,T[X])≧(K) Formula 1
where: E is the metered activity from N number of pre-selected elements/devices of application usage, T is threshold(s) values that define(s) the limits for when an activity is considered idle (typically every activity is tested with one and only one threshold value, but the invention need not necessarily be implemented that way). In principle, a single threshold value T can be used by a combination of activities, E. X is the number of thresholds used and K is a predetermined value that defines when the subject application is considered idle.

In principle, ƒ can be any function returning a number, but ƒ most simply may be implemented as a weight function that is well suited for this purpose. The weight function that is specific to a given application is implemented as follows.

Four such elements E are currently pre-defined. These are designated E[1] to E[4], where E[1] corresponds to KB, E[2] to MA, E [3] to CPU and E[4] to I/O, as defined above in the discussion of Step 103. In principle, however, any number of elements can and may be added to the function, so that if other transducers and/or devices are interacting with the application, they too, may be considered relevant for the weighting function and added to the computation.

For each element E, there is a designated threshold (T), and each element is tested against this threshold, so that the expression E<=T yields 1 if the activity measured for element E is above the threshold, and 0 otherwise. The most common situation would be to set the threshold to 0, that is, any activity would result in the expression E<=T returning a one (1) for the associated transducer or device, but in principle T may be set to any value.

The variables W[1] to W[N] are weight factors which are assigned to each of the elements that should be considered. Finally, K is a real number that designates the criteria for causing the application to be disabled.

Considered together, the formula for determining whether or not an application is idle can be expressed as:

$$( [ {\sum }_{i = 1}^{N} ( E [ i ] \leq T [ i ] ) \times W [ i ] ] \geq K ) \qquad Formula 2$$

For example, if W[1] is 1, and all other (W[2] to W[N]) are 0, then only activity associated with E[1] (keyboard) counts.

On the other hand, if W[1] to W[N] all are set to 1 and K is set to N, then the function alternatively may be written as follows:
AND (E[1]≦T[1],E[2]≦T[2],E[3]≦T[3],E[4]≦T[4])) Formula 3
In this form of the function, all activity counts and the application will only be disabled if the activities of all elements are below the threshold.

In order to determine the weights factors (W[i]), the threshold values (T[i]), and the K value for a specific application, one needs in-depth knowledge about the business and the application. The final rules, as expressed by the parameters in the above function, depend on and are a function of the values assigned to (or pre-selected for) these parameters. As shown in the flowchart diagram, these values are input from a policy module (110), and are designated: Trigger points, Thresholds, License Usage, License Rules and Business Rules. It will be evident to one skilled in the art from a consideration of the principles of the invention described herein that the values are likely to vary depending on, for example, the time of the day, or the immediate need of the organization on which they are used. In general, the rules are determined based on the policies of the organization using the invention in combination with the operator/consultants-experience in configuring the inventive program to “tune the process” with respect to its application to the organization. That is, the inventive program and process has a wide degree of flexibility and configurability for adaptation to a given organization's suite of applications and license package(s). The program also includes organized, flexible, and easy-to-update storage of this enterprise policy module values, e.g. by database, configuration template data storage and the like. In addition the inventive program also includes pre-selected default rules which may function as a normative approach, or typical configuration for non-customized installation and operation of the program.

Even if the application is considered idle, by applying the above formulas, the user may still be given a choice to prevent going to step 105. For example, within 104, where the application is interactive and pre-selected or default criteria are met a user may be given the option to block the disablement, or block for a limited period, or be automatically re-enabled or re-instated. Criteria at this step can include user, task or project eligibility or ranking, and the like.

Step 105—Invalidate License Requirements; Application Instance Disabled

An instance of an application may be considered to be not in need of a license when the application is:
1. Uninstalled
2. Corrupted (so it is not able to run)
3. Dekeyed
4. Terminated
5. Hibernated or
6. Suspended
   This means that the application is not able to do anything before this action is reversed (i.e. reinstalled, recovered from corruption, rekeyed, restarted, activated or continued.) As noted in the definitions above, for simplicity, where the instance of the program has executed “an operation to invalidate requirements for having a license to an instance of a software product” is termed “DISABLE”, and operation of reversing that for useful operation is termed “ENABLE”. Which of the above 6 methods that have to be executed in order to disable an application depends on the software contract between the customer and the software vendor and the system in which the software operates.

However, it is an important step in the inventive process that the program only executes the disabling operation that is the least disrupting for the user (operation that is minimally disruptive to the user). For example, in the hierarchy of disablement, it is less disrupting to suspend than to terminate an application, and it is less disruptive to terminate than to uninstall an application. Implementation of methods of disablement is will within the skill in the art; a few exemplary methods are as follows:
Suspend: Suspending an application in UNIX, can be done by executing “KILL STOP” on the processes associated with an instance of an application. On Windows all treads of the corresponding processes are identified and suspended individually.
Dekey: Identifying the license registry entry or the link to the application and removing them.
Corrupt: Corrupting an application may be done, e.g., by applying a reversible encryption of the first few bytes (typically one kb), or the whole program file. One exemplary method is the DES encryption algorithm described in Ehrsam et al., U.S. Pat. No. 3,962,539, Issued: Jun. 8, 1976 (IBM).

Step 106—Freeing-Up a License

Where the enterprise is using a license manager program, the inventive program includes the process step of contacting the license manager to free the license by returning the software license to the license manager, if supported by the license manger. The license can then be carried in inventory in the license manager program or data base. Even if the application does not use a license manager, this step may still include the necessary action to flag the application as disabled by contacting a suitable software repository service or program (one among several available is provided by Open iT of Houston, Tex. and Oslo, NO).

Step 107—Is the Application Interactive?

If the application accepts keyboard or mouse input, or any other interactive device associated with it, the application is considered to be interactive, and the process branches to continue to Step 108 (go to P1, FIG. 1b). If no such input, continue at Step 109 (go to P2, FIG. 1c).

Step 108—Interactive Application:

Start (fork) a new task as described in FIG. 1b.

Step 109—Non-Interactive Application:

Start (fork) a new task as described in FIG. 1c.

7.2 FIG. 1b

In the case of an interactive application the user is informed of the activity of the inventive license management program by providing at Step 201 a window or text as pop-up that appears on the user's desktop, and the program waits for response from the user. This is an example of a menu of options being available to users advising of actions taken and their options under the policies, rules or thresholds established by the enterprise. The reactivation or re-enabling options may be conditional upon a variety of configurable criteria, including eligibility or priority of the user or project whose license has been harvested. A typical notice to the user requesting a response may be as follows (not necessarily with the exact wording):
“You were running an instance of Application X that has been disabled due to inactivity, and the license(s) required for running this application has been removed. Click the “YES” to re-activate the license to enable you to use the application. Click the “NO” to indicate you agree the application should remain disabled.”

The inventive program then waits for the user to respond. If he/she responds with “NO” in 202, then process of disabling happens, with the termination and clean up 208, etc. in whichever order as applicable to the environment. Otherwise, the program will check if there are any licenses available (203). If upon checking with the license manager (program or the configuration data in the inventive program), it is determined by the inventive program that the user is not authorized or there is no license available for the user's application, the user receives a warning, 204, that no licenses are available, and the program continues to wait for the next user input into the user dialog box. Alternatively depending on the user's priority or other eligibility criteria, the user may be granted priority reinstatement (re-enblement), at which time a notice of reinstatement pops-up on the user's desktop.

If there is a license available, the license will be reactivated 205, if permitted by the license manager.

Returning to FIG. 1b, if authorized and other criteria are met, the application will then be enabled or re-enabled, Step 206, for example by being reinstalled, recovered from corruption, rekeyed, re-started, activated or continued, depending on what was done to disable the application. That is, the disabling operation will be reversed. It will be evident to one skilled in the art what needs to be done to reverse the carefully-designed disabling operation. Finally, the user will receive information that the application has been enabled, or re-enabled, 207.

7.3 FIG. 1c

In cases where the application is non-interactive, Step 301 is a system request for enabling the application. Once the request is made, the inventive program will check if there are any licenses available. 302. If there are no licenses available a warning message is sent to the license request source 303.

If there is a license available, the license will be reactivated if permitted by the criterion of the license manager 304. The application will then be enabled or re-enabled, 305, e.g., by being reinstalled, recovered from corruption, rekeyed, restarted, activated or continued, depending on what was done when the application was disabled.

The “no” branch leading to 306 is less likely to occur, but it is included for the sake of completeness.

8 Operation of the Inventive Process and Program to Achieve Efficient and Optimal Use of Program Licenses to Lower Overall Costs to Enterprises:

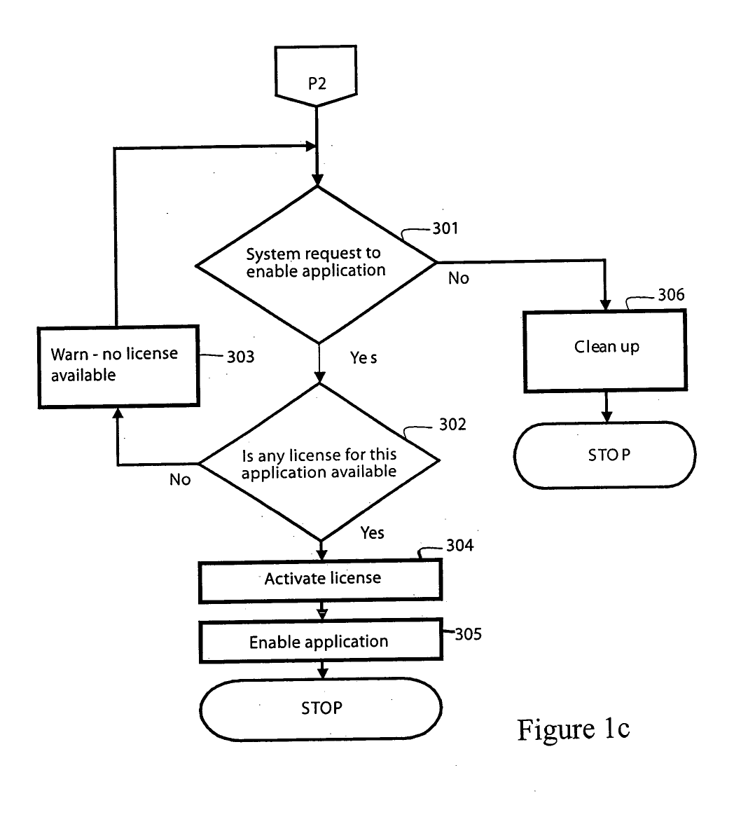

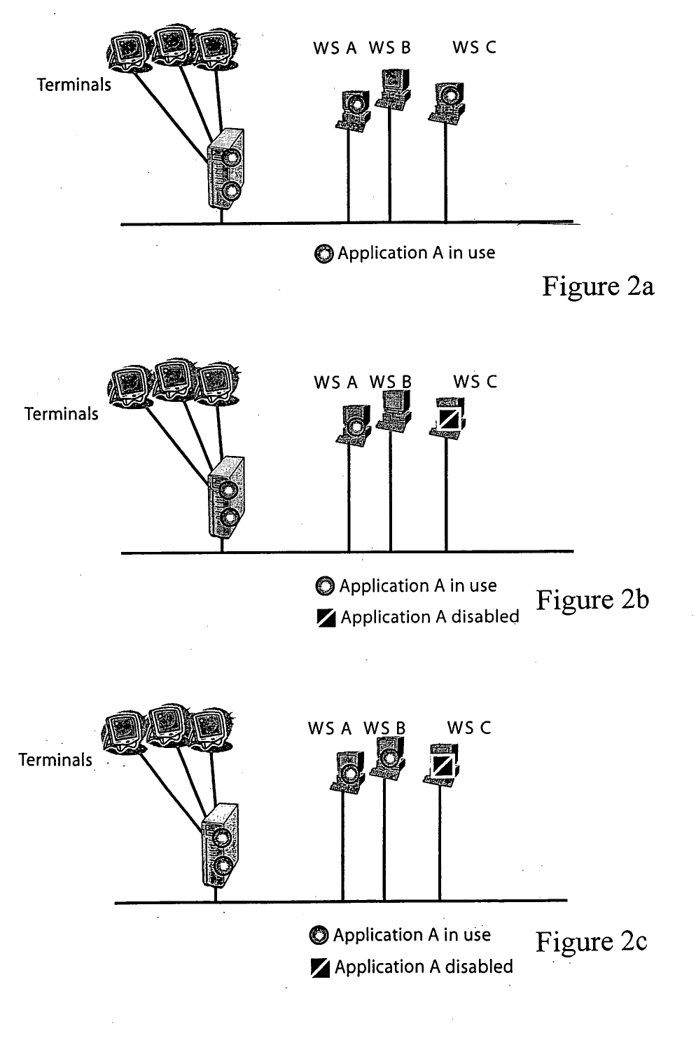

An operation of the invention is shown in FIG. 2a. In this example, currently there are 4 instances of Application ‘A’ running in the enterprise system setup consisting of one server, 3 terminals and 3 workstations (WS). And there are only 4 licenses available to run the Application ‘A’.

FIG. 2b illustrates the automated monitoring of the system of FIG. 2a by the inventive program. Due to lack of activity on the process(es) on one of the host, say WS C, the application concerned was automatically disabled (suspended), FIG. 1a Step 105, and the license is freed up, FIG. 1a, Step 106. We now have only 3 instances of application ‘A’ that are enabled to run, but 4 licenses remain, the freed-up license having been returned, for example, to the license manager.

Finally, turn to FIG. 2c. Since we are allowed to have 4 instances at the same time, another user may now use this application, either on this or another host, for example, WS B, as long as there is no violation of the license agreement of the enterprise (i.e., there must be a license available). In this instance, since the fallow license of WS C was freed-up and returned to the license manager, one license is in inventory and redistribution is not in violation of the agreement with the software vendor. The application on WS C will remain disabled until another license is freed up or paid-for, and that license is enabled on WS C.

9 Alternative Embodiment of the Inventive Process and Computer Program Driven Automatic Monitoring and Management of Application Licenses:

The example above is straight-forward, an active application was disabled due to its activity level dropping below a predetermined and selected (configured) threshold. Another exemplary embodiment involves different criteria:
a) Instead of focusing on idleness (fallow applications), one may focus on minimizing license usage in the following way: A user that is using application A and needs to access application B in order to complete its operation, and thus free the licenses for both applications A and B, may be given priority over someone who just wants to use application B. That is, the Business Rule determinant of the policy module sets as an input priority to the inventive process, the evaluation of linked applications, here B is linked and follows A, and a monitoring of, in this example, application A. Where A is seen in use, the inventive process puts a prospective assignment of license for B for the in-process user of A. Or at the time of user 2 requesting B, where user 2 is not inprocess on A, all other users are polled and if a user 1 is found to have A in process, 2 is denied until 1 is done with A+B. One skilled in the art will be able to define the enable a hierarchical set of business rules to suit particular enterprise requirement.
b) Adding priority to the threshold and trigger rules from the policy module of FIG. 1a as inputs to Steps 102 and 104, simply means that a running application with low priority can (of course with notice to the user) be disabled to permit a job with higher priority to be completed efficiently, without break. Thus, the inventive process and program configuration features permits assigning priority to jobs, users, hosts and/or sites.
c) For interactive applications only: Instead of just disable an application, the invention may ask the user if he accept that the software will be disabled. Unless he explicitly says yes, the software will be disabled.
   10 Actual Operating Example

The program as described herein, including the essential functionality outlined in the Summary has been alpha site implemented under conditions of confidentiality in Company A.

10.1 Background:

Company A has committed to renting 150 concurrent licenses to cover the needs of 250 users, from Company B. However, Company A is not hindered by lack of availability of licenses should the demand exceed 150 licenses, the two companies having agreed that a buffer of 30 licenses is permanently available to Company A. If this buffer is used, Company A agrees to pay for additional rental. Company B has in place the necessary tools to monitor these events in Company A.

10.2 The Problem:

Company A experiences that its usage is tight, running up against the 150 trigger. Company A regularly tips over and uses more than 150 licenses, incurring resultant license contract penalty clauses and additional costs. Management suspects that application programs are being started and licenses being checked out in the ordinary course of business, but the licensed users are not returning licenses when not at their desk, e.g., still running applications when at meetings, lunch, coffee breaks, etc. It is important that no data should be lost or corrupted, and the application should be “disabled” in the least disrupting way for the user.

10.3 The Inventive Process and Program Solution

The inventive process was implemented in a software program that operated as described herein with the following program features:
1. It runs a background process to monitor CPU and license usage of the users of particular programs and applications and their associated processes (objects). It maintains a list of these objects.
2. The program monitor period is configurable and varies from application to application.
3. The program only begins to monitor if total license usage approaches 125. That number is selectably configurable. That is, the inventive program process kicks in at a selected level lower than the number of licenses purchased.
4. The program only monitors a user if the user has a license. That is, it monitors the use of licensed users.
5. The program triggers “freeze” function on the following conditions (configurable):
   a. CPU usage is idle for all associated processes using that license; and
   b. A license has actually been checked out by that user.
6. On freeze the program does the following:
   a. Logs the event anonymously;
   b. Pops-up a warning window informing him/her of license withdrawal and freeze, and also gives him/her the option to thaw the application(s);
   c. Freezes the application and associated objects with least disruption;
   d. Withdraws license-which in effect makes it available to others.
7. The application waits, remains frozen, inactive, until the user thaws the application via a dialog menu displayed on the desktop;
8. On thawing selection by the user, the following is executed by the program:
   a. Removes Freeze Notification pop-up window;
   b. Thaws the application and the associated objects; and
   c. Permits the application to reclaim the necessary license itself.
      11 Industrial Applicability:

It is clear that the inventive method and management program has wide applicability to the software industry, namely to all organizations that utilize multiple user licenses and have substantial turn-over of personnel and continuously changing demands for application software.

The inventive method and program system clearly identifies fallow program usages, manages efficient and optimal usage in order to lower the overall software costs by reducing the number of licenses required through-out an entire organization. Thus, the inventive method and software program has the clear potential of becoming adopted as the new standard for cost effective software rights management.

It should be understood that various modifications within the scope of this invention can be made by one of ordinary skill in the art without departing from the spirit thereof and without undue experimentation. For example, the program can determine the various suites of related programs that are common in an organization, identify those users who do not have access and use rights to missing ones of the suite (user candidates), and automatically notify such candidates when rights become available that they can now have access/use rights to the missing program or programs of the suite. This invention is therefore to be defined by the scope of the appended claims as broadly as the prior art will permit, and in view of the specification if need be, including a full range of current and future equivalents thereof.

1. Method of computer-enabled monitoring and controlling usage of software applications under bulk software licenses to organizations having a plurality of computers, servers or workstations in a networked configuration that are accessed and utilized by a plurality of users, comprising the steps of:
a) monitoring usage of instances of selected applications on said computers, servers or workstations to identify levels of inactivity of said selected applications by said users based on metering the activity level including user input device activity with respect to the selected applications being monitored;
b) disabling inactive ones of said selected applications on individual ones of said computers, servers or work stations pursuant to pre-determined criteria by invalidating the requirement for having a license to the said instance of the software; and
c) said steps of monitoring and disabling are effected automatically through said network.

2. Method as in claim 1 which includes the additional step of making rights to licensed but disabled ones of said selected applications available to other users on said network of the organization to efficiently and cost-effectively utilize the bulk software license usage rights of the organization and reduce the software cost to said organization.

3. Method as in claim 1 which includes the additional step of notifying the users of applications that have been disabled of the action taken, and providing said users a menu of choices of response.

4. Method as in claim 3 wherein the step of determining the inactivity of any one of said applications is done by evaluating the function:
ƒ(E[1],E[2], . . . ,E[N],T[1],T[2], . . . ,T[X])≧(K),
where: E is the metered activity from N number of pre-selected devices/entities, T is at least one threshold value that defines when devices/entities are considered active or idle, X is the number of thresholds used, and K is a pre-determined value that defines that the said application is idle where the solution f returns greater or equal to K.

5. Method as in claim 4 wherein N is four, representing four predetermined devices designated E[1] to E[4], where E[1] corresponds to metered keyboard activity, E[2] to metered mouse activity, E [3] to metered CPU activity and E[4] to metered I/O activity by said application instance in a selected period/interval, T[1] through T[4] are the respective threshold values of E[1] through E[4], and wherein the function f is:
ƒ(E[1]≦T[1], E[2]≦T[2],E[3]≦T[3],E[4]≦T[4])),
which upon solution returns a number value.

6. Method as in claim 5 wherein, when said returned number value is greater or equal to the disable value (K):
ƒ(E[1]≦T[1],E[2]≦T[2],E[3]≦T[3],E[4]≦T[4]))≧K,
the instance of the application object is defined as IDLE.

7. Method as in claim 6 wherein:
ƒ(E[1]≦T[1],E[2]≦T[2],E[3]≦T[3],E[4]≦T[4]))≧K,
is expressed as a Boolean expression of said four predefined values of E[i]:
BOOL(E[1]≦T[1],E[2]≦T[2],E[3]≦T[3],E[4]≦T[4])).

8. Method as in claim 6 wherein:
ƒ(E[1]≦T[1],E[2]≦T[2],E[3]≦T[3],E[4]≦T[4]))≧K,
is expressed as a weighted function:
$$( [ {\sum }_{i = 1}^{N} ( E [ i ] \leq T [ i ] ) \times W [ i ] ] \geq K ) ,$$
which function, when true, the instance is idle.

9. Method as in claim 3 wherein said disabling frees up licenses and which includes the added step of retaining said freed-up licenses as candidates for redistribution to users of said organization pursuant to defined rules of said organization.

10. Method as in claim 9 wherein said freed-up licenses are maintained in a database repository as a pool for said redistribution.

11. Method as in claim 1 wherein pre-determination of said criteria includes the step of assigning different use priorities to at least one of different users, groups, hosts, tasks, projects and times for disabling a license in said organization.

12. Method as in claim 2 which includes the steps of:
a. determining for a given organization at least one suite of commonly used applications as at least one of said selected applications;
b. identifying at least one first user who has at least one application in said suite of applications but is not using at least one application in said suite;
c. identifying at least one second user who is missing at least one of the applications in said suite of applications; and
d. alerting said second user of the availability of usage rights to said missing application upon said missing application usage rights becoming available.

13. Method as in claim 9 which includes the steps of:
a. determining for a given organization at least one suite of commonly used applications as at least one of said selected applications;
b. identifying at least one first user who has at least one application in said suite of applications but is not using at least one application in said suite;
c. identifying at least one second user who is missing at least one of the applications in said suite of applications; and
d. alerting said second user of the availability of usage rights to said missing application upon said missing application usage rights becoming available.

14. Method as in claim 11 wherein a high priority user is guaranteed access to a application.

15. Method as in claim 14 wherein said access by said high priority user is selected from providing an available license from a license inventory, and harvesting a license from a lower priority user or activity by disabling the license of said lower priority user or activity user.

16. Method as in claim 3 wherein said notified user menu of options includes giving the user an option of blocking the disablement of a application under pre-determined criteria.

17. Method as in claim 16 wherein said blocking option includes at least one of a delay period of time before the application is disabled, and permitting blocking if said user's priority ranking is above a criteria threshold.

18. Method as in claim 16 wherein said user is permitted automatic reinstatement of a disabled application based on pre-determined eligibility criteria, including the user's priority ranking.

19. Method as in claim 18 wherein at the time of automatic reinstatement, a notice of reinstatement pops-up on the user's desktop.

20. Method as in claim 1 which includes the added step of automatically re-enabling a application that has been disabled.
